(19) United States
(12) Patent Application Publication
(10) Pub. No.: US 2015/0356608 A1
(43) Pub. Date: Dec. 10, 2015

(54) SELECTING ADVERTISEMENT CONTENT FOR SOCIAL NETWORKING SYSTEM USERS BASED ON TYPES OF LOCATION DATA ASSOCIATED WITH THE USERS

(71) Applicant: Facebook, Inc., Menlo Park, CA (US)

(72) Inventor: Erick Tseng, San Francisco, CA (US)

(21) Appl. No.: 14/300,309

(22) Filed: Jun. 10, 2014

(51) Int. Cl. G06Q 30/02; G06Q 50/00

(52) U.S. Cl. CPC G06Q 30/0261; G06Q 30/0269; G06Q 50/01

(57) ABSTRACT

A social networking system determines whether an advertisement (“ad”) request is eligible for presentation to a user based on a physical location associated with the user and targeting criteria included in the ad request. Physical locations associated with the user are each associated with a location type, and the ad request's targeting criteria specifies a physical location and minimum measures of ad quality associated with various location types. If a physical location associated with the user satisfies the physical location specified by the targeting criteria, the social networking system identifies a minimum measure of ad quality associated with a location type of the physical location associated with the user by the targeting criteria. A measure of the user's affinity for advertisement content included in the ad request is determined and used along with the identified minimum measure of ad quality to determine if the user satisfies the targeting criteria.

### BACKGROUND

This disclosure relates generally to social networking systems, and in particular to identifying advertisement content eligible for presentation to a social networking system user.

A social networking system allows users to connect to and to communicate with other users of the social networking system. Users create profiles on a social networking system that are tied to their identities and include information about the users, such as interests and demographic information. The users may be individuals or entities such as corporations or charities. Because of the increasing popularity of social networking systems and the significant amount of user-specific information maintained by social networking systems, a social networking system provides an ideal forum for advertisers to increase awareness about products or services by presenting advertisements to social networking system users.

Presenting advertisements to social networking system users allows an advertiser to gain public attention for products or services or to persuade social networking system users to take an action regarding the advertiser's products or services. Many social networking systems generate revenue by displaying advertisements to their users. Frequently, social networking systems charge advertisers for each presentation of an advertisement to a social networking system user (e.g., each “impression” of the advertisement) or interaction with an advertisement by a social networking system user.

To increase the likelihood of social networking system users interacting with an advertisement, various targeting criteria may be associated with the advertisement. The advertisement is subsequently presented to users having characteristics satisfying the targeting criteria. Frequently, targeting criteria associated with an advertisement specify a physical location, so the advertisement is eligible for presentation to users within a threshold distance of the specified physical location. However, the social networking system may associate multiple physical locations with a user, so a physical location associated with the user may satisfy an advertisement's targeting criteria but may not correspond to the current location of the user. This may result in selection of advertisements with which the user is less likely to interact for presentation to the user.

### SUMMARY

A social networking system evaluates one or more physical locations associated with a user of the social networking system when determining wither the user satisfies targeting criteria included in an advertisement request (“ad request”). A location type is associated with each physical location associated with the user identifying a source of data specifying a physical location or another suitable characteristic of the physical location. For example, one location type identifies a static physical location specified by a user (e.g., a hometown, a residence), another location type identifies a physical location identified from content provided to the social networking system by the user (e.g., a location identified by a post to the social networking system by the user, a location to which a user checks-in via a client device), and yet another location type identifies a physical location identified by information communicated to the social networking system by a client device associated with the user (e.g., position information from a position sensor included in the client device). Additionally, the targeting criteria specifies a physical location and associates minimum measures of advertisement (“ad”) quality with different location types, where a minimum measure of ad quality associated with a location type specifies a minimum measure of affinity for advertisement content included in the ad request for a user to be eligible for advertisement content in the ad request.

When an opportunity to present advertisement content to the user is identified by the social networking system, the social networking system determines whether a physical location associated with the user satisfies the physical location specified by targeting criteria included in the ad request. For example, the social networking system determines whether a physical location associated with the user matches the physical location specified by the ad request's targeting criteria or whether a physical location associated with the user is within a threshold distance of the physical location specified by the ad request's targeting criteria. If a physical location associated with the user satisfies the ad request's targeting criteria, the social networking system identifies a minimum measure of ad quality from the targeting criteria associated with a location type of the physical location associated with the user. Additionally, the social networking system determines a measure of ad quality for the user based at least in part on an affinity of the user for advertisement content included in the ad request. The measure of ad quality may be determined based on characteristics of the user, characteristics of the advertisement content, and/or the targeting criteria.

The social networking system determines whether the user satisfies the targeting criteria included in the ad request based on the identified minimum measure of ad quality and the measure of the user's ad quality for the advertisement content in the identified ad request. In one embodiment, the social networking system ranks the measure of ad quality for the user along with measures of other users' affinity for the advertisement content included in the ad request. Based on the ranking and the identified minimum measure of ad quality, the social networking system determines whether the user satisfies the identified ad request's targeting criteria. For example, the social networking system determines the user satisfies the ad request's targeting criteria if the measure of ad quality determined for the user is within a range of the ranking including a percentage of users' measures of affinity for the advertisement content (e.g., if the measure of ad quality for the user is within the top 10%, top 25%, top 30%, etc. of the users' measures of affinity for the advertisement content) specified by the identified minimum measure of ad quality. As another example, the social networking system determines the user satisfies the identified ad request's targeting criteria if the measure of ad quality for the user is in at least a percentile of the users' measures of affinity for the advertisement content specified by the identified minimum measure of ad quality. Hence, the user is determined to satisfy the ad request's targeting criteria if a physical location associated with the user satisfies a physical location specified by the ad request's targeting criteria and the measure of ad quality for the user satisfies a minimum measure of ad quality associated with a location type associated with the physical location in the user profile specified by the targeting criteria.

### BRIEF DESCRIPTION OF THE DRAWINGS

FIG. 1 is a block diagram of a system environment in which a social networking system operates, in accordance with an embodiment.

FIG. 2 is a block diagram of a social networking system, in accordance with an embodiment.

FIG. 3 is a flowchart of a method for identifying advertisement content for presentation to a user based on location types associated with the user, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

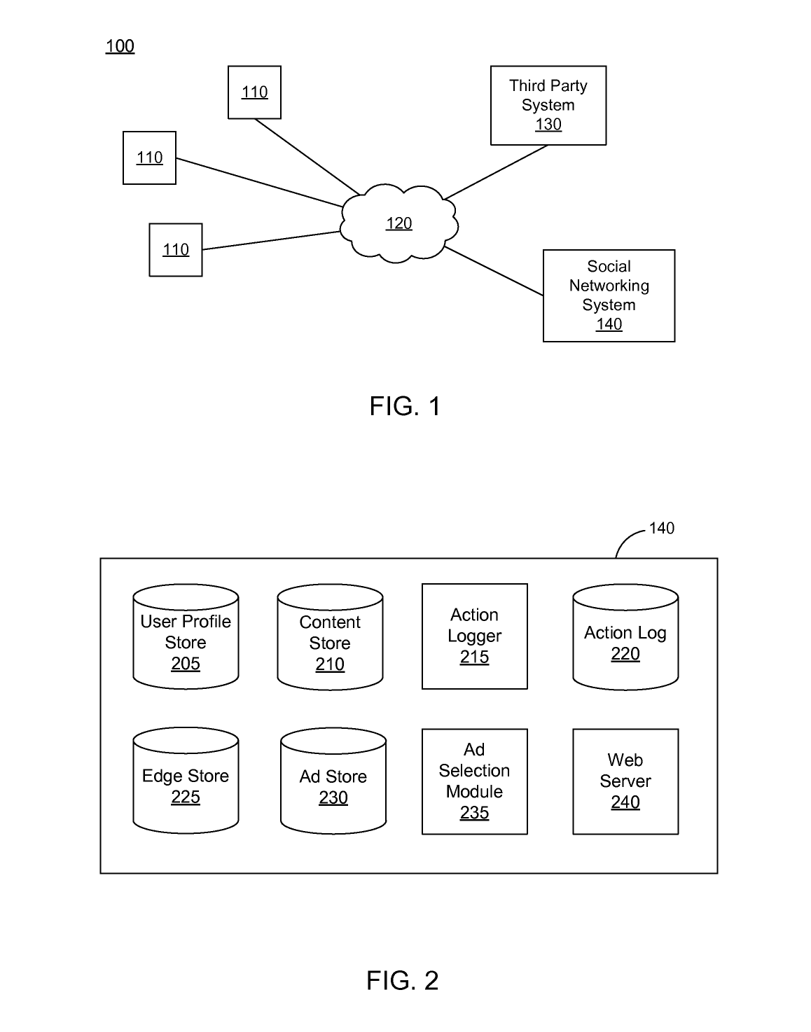

FIG. 1 is a block diagram of a system environment 100 for a social networking system 140. The system environment 100 shown by FIG. 1 comprises one or more client devices 110, a network 120, one or more third party systems 130, and the social networking system 140. In alternative configurations, different and/or additional components may be included in the system environment 100. The embodiments described herein can be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) running on a native operating system of the client device 110, such as IOS® or ANDROID™

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the social networking system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the social networking system 140, such as advertisements, content, or information about an application provided by the third party system 130.

FIG. 2 is a block diagram of an architecture of the social networking system 140. The social networking system 140 shown in FIG. 2 includes a user profile store 205, a content store 210, an action logger 215, an action log 220, an edge store 225, an advertisement (“ad”) store 230, an ad selection module 235, and a web server 240. In other embodiments, the social networking system 140 may include additional, fewer, or different components for various applications. Conventional components such as network interfaces, security functions, load balancers, failover servers, management and network operations consoles, and the like are not shown so as to not obscure the details of the system architecture.

Each user of the social networking system 140 is associated with a user profile, which is stored in the user profile store 205. A user profile includes declarative information about the user that was explicitly shared by the user and may also include profile information inferred by the social networking system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image. A user profile in the user profile store 205 may also maintain references to actions by the corresponding user performed on content items in the content store 210 and stored in the action log 220.

In various embodiments, multiple physical locations associated with a user are included in the user's user profile. A location type is associated with each physical location and describes one or more characteristics of the physical location. For example, a location type specifies a source from which the physical location was determined. In one embodiment, a location type associated with a physical location is selected from a set of location types. For example, a location type identifies a static physical location specified by a user (e.g., a hometown, a residence) or inferred from information associated with the user, another location type identifies a physical location identified in content provided to the social networking system 140 by the user (e.g., a location identified by a post to the social networking system 140 by the user, a location to which a user checks-in via a client device 110), and an additional location type identifies a physical location identified by information communicated to the social networking system by a client device 110 associated with the user (e.g., Global Positioning System coordinates communicated to the social networking system 140 by a client device 110 executing an application associated with the social networking system 140). However, in other embodiments, a location type associated with a physical location may identify any suitable characteristic, of combination of characteristics, of the physical location. Additionally, in some embodiments, the location type identifies a current physical location of the user. For example, the social networking system determines if a physical location associated with the user is the user's current physical location of the user by comparing a time stamp associated with information received from the client device 110 (e.g., via the information communicated to the social networking system by the client device 110 associated with the user and/or the content provided to the social networking system 140 by the user discussed above) with a current time. If a difference in the compared times is less than a threshold value, the social networking system identifies the physical location associated with the user is the current location of the user.

Associating different location types with different physical locations allows a user profile to provide an indication of how likely a user is to be currently associated with the different physical locations. For example, a physical location associated with a location type indicating the physical location was identified by information received by the social networking system 140 from a client device 110 has a relatively higher likelihood of being associated with a user at a current time than a physical location associated with a location type indicating physical location is a user-specified static physical location. The social networking system 140 may determine a location type associated with a physical location based on additional information received in conjunction with the physical location. In some embodiments, metadata specifying a location type is received by the social networking system 140 in conjunction with a physical location.

While user profiles in the user profile store 205 are frequently associated with individuals, allowing individuals to interact with each other via the social networking system 140, user profiles may also be stored for entities such as businesses or organizations. This allows an entity to establish a presence on the social networking system 140 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 210, such as status updates, photos tagged by users to be associated with other objects in the social networking system, events, groups or applications. In some embodiments, objects are received from third-party applications or third-party applications separate from the social networking system 140. In one embodiment, objects in the content store 210 represent single pieces of content, or content “items.” Hence, social networking system users are encouraged to communicate with each other by posting text and content items of various types of media to the social networking system 140 through various communication channels. This increases the amount of interaction of users with each other and increases the frequency with which users interact within the social networking system 140. In one embodiment, the content store 210 includes one or more user identifiers that identify one or more social networking system users presented with a content item that are stored in association with the stored content item.

The action logger 215 receives communications about user actions internal to and/or external to the social networking system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the social networking system 140 to track user actions on the social networking system 140, as well as actions on third party systems 130 that communicate information to the social networking system 140. Users may interact with various objects on the social networking system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the social networking system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the social networking system 140 as well as with other applications operating on the social networking system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the social networking system 140. For example, an e-commerce website may recognize a user of a social networking system 140 through a social plug-in enabling the e-commerce website to identify the user of the social networking system 140. Because users of the social networking system 140 are uniquely identifiable, e-commerce websites, such as in the preceding example, may communicate information about a user's actions outside of the social networking system 140 to the social networking system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the social networking system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 140, such as expressing interest in a page on the social networking system 140, sharing a link with other users of the social networking system 140, and commenting on posts made by other users of the social networking system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the social networking system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the social networking system 140 over time to approximate a user's interest in an object or another user in the social networking system 140 based on the actions performed by the user. A user's affinity may be computed by the social networking system 140 over time to approximate a user's interest for an object, interest, or other user in the social networking system 140 based on the actions performed by the user. Computation of affinity is further described in U.S. patent application Ser. No. 12/978,265, filed on Dec. 23, 2010, U.S. Patent Application No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the ad request store 230. An advertisement request includes advertisement content and a bid amount. The advertisement content is text, image, audio, video, or any other suitable data presented to a user. In various embodiments, the advertisement content also includes a landing page specifying a network address to which a user is directed when the advertisement is accessed. The bid amount is associated with an advertisement by an advertiser and is used to determine an expected value, such as monetary compensation, provided by an advertiser to the social networking system 140 if the advertisement is presented to a user, if the advertisement receives a user interaction, or based on any other suitable condition. For example, the bid amount specifies a monetary amount that the social networking system 140 receives from the advertiser if the advertisement is displayed and the expected value is determined by multiplying the bid amount by a probability of the advertisement being accessed.

Additionally, an advertisement request may include one or more targeting criteria specified by the advertiser. Targeting criteria included in an advertisement request specify one or more characteristics of users eligible to be presented with advertisement content in the advertisement request. For example, targeting criteria are used to identify users having user profile information, edges or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the social networking system 140. Targeting criteria may also specify interactions between a user and objects performed external to the social networking system 140, such as on a third party system 130. For example, targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in targeting criteria allows advertisers to further refine users eligible to be presented with content from an advertisement request. As another example, targeting criteria identifies users having a connection to another user or object or having a particular type of connection to another user or object.

Targeting criteria included in an advertisement request may identify a physical location as well as a set of minimum measures of advertisement (“ad”) quality associated with various location types. As described above, a physical location may be associated with a location type describing one or more characteristics of the physical location. A minimum measure of ad quality associated with a location type is based at least in part on a minimum measure of affinity of a user for advertisement content included in the ad request for the ad request to be eligible for presentation to a user associated with a physical location having the location type and satisfying the physical location identified by the targeting criteria. For example, a measure of ad quality provides an indication of a user's likelihood of interacting with advertisement content in an ad request. In one embodiment, the minimum measure of ad quality specifies a percentage of measures of affinity of multiple social networking system users for advertisement content in an ad request, so the ad request is eligible for presentation to a user having a measure of ad quality within the specified percentage of a ranking of the measures of affinity. Alternatively, a minimum measure of ad quality specifies a percentile in a ranking of measures of affinity of multiple social networking system users to identify users having a measure of ad quality within the specified percentile. In other embodiments, the minimum measure of ad quality may specify a minimum measure of affinity between a user and advertisement content in an ad request.

Associating different minimum measures of ad quality with different location types allows an advertiser to increase or decrease distribution of advertisement content to users based on different location types associated with physical locations satisfying targeting criteria associated with the advertisement content. For example, associating different minimum measures of ad quality with different location types allows advertisement content to be identified as eligible for presentation to users associated with a physical location that satisfies targeting criteria and that is indicated as specified by information received from a client device 110 when the users have a relatively lower measure of affinity for the advertisement content than users associated with a physical location satisfying the targeting criteria and associated with a location type indication the physical location is a static location specified by the user. Additionally, an advertiser may associate different bid amounts with different location types to further modify the likelihood of advertisement content being presented to users based on a location type associated with a user's physical location satisfying targeting criteria associated with advertisement content.

When an opportunity to present advertisement content to a user of the social networking system 140 is identified, the advertisement (“ad”) selection module 235 identifies one or more ad requests from the ad store 230 eligible for presentation to the and selects one or more of the eligible ad requests for presentation to the user. To identify ad requests eligible for presentation to a user, the ad selection module 235 retrieves information associated with the user from one or more of the user profile store 205, the action log 220, and the edge store 225 and compares the retrieved information to targeting criteria included in various ad requests from the ad store 230. Ad requests including at least a threshold number or percentage of targeting criteria satisfied by the retrieved information associated with the user are identified as eligible for presentation to the user and included in a selection process to select advertisement content from one or more ad requests for presentation to the user.

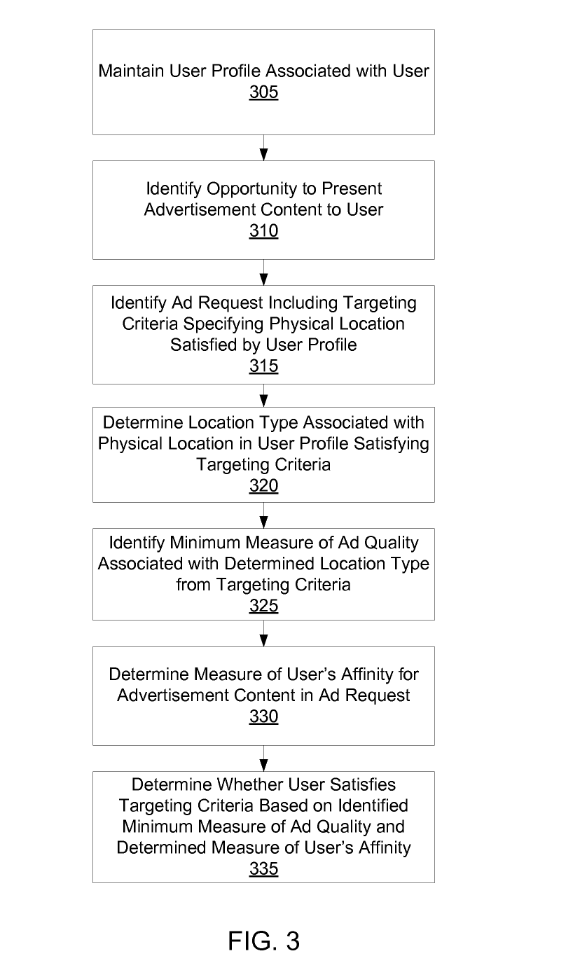

To determine if a user is associated with information satisfying a physical location identified by targeting criteria, the ad selection module 235 accounts for a location type associated with a physical location associated with the user. If a user's user profile includes a physical location matching or within a threshold distance of a physical location specified by targeting criteria of an ad request, the ad selection module 235 identifies a location type associated with the physical location associated with the user that satisfies the targeting criteria. Additionally, the ad selection module 235 determines a measure of ad quality of the advertisement content in the ad request for the user based on characteristics of the ad request, the targeting criteria, and characteristics of the user from the user profile store 205, the content store 210, or the edge store 225. For example, the ad selection module 235 determines a measure of affinity of the user for advertisement content identified by the ad request based on characteristics of the user and characteristics of the advertisement content and determines the ad quality of the advertisement content for the user based at least in part on the determined measure of affinity. The ad selection module 235 retrieves a minimum measure of ad quality associated with the identified location type from the targeting criteria of the ad request and determines whether the measure of ad quality for the user satisfies the retrieved minimum measure of ad quality. For example, the ad selection module 235 determines whether the measure of ad quality for the user has at least a position in a ranking of measures of affinity of various users for the advertisement content specified by the retrieved minimum measure of ad quality. If the ad quality for the user satisfies the minimum measure of ad quality associated with the identified location type specified by the targeting criteria of the ad request, the ad selection module 235 identifies the ad request as eligible for presentation to the user. Use of location types to identify ad requests eligible for presentation to a user is further described below in conjunction with FIG. 3.

Ad requests identified as eligible for presentation to the user are included in a selection process that identifies advertisement content associated with one or more ad requests for presentation to the user. In one embodiment, the ad selection module 235 uses an auction process that ranks eligible ad requests based on expected values to the social networking system 140 for presenting advertisement content from each of the eligible ad requests, with an expected value of an ad request based on a bid amount associated with the ad request and a likelihood of the user interacting with advertisement content in the ad request. Based the ranking, the ad selection module 235 selects one or more of the eligible ad requests and communicates advertisement content from the selected ad requests to a client device 110 for presentation to the user. The ad selection module 235 also determines an amount charged to an advertiser associated with a selected ad request based on bid amounts or expected values associated with various ad requests included in the selection process. In various embodiments, any suitable process for selecting ad requests may be applied to the eligible ad requests by the ad selection module 235.

The web server 240 links the social networking system 140 via the network 120 to the one or more client devices 110, as well as to the one or more third party systems 130. The web server 240 serves web pages, as well as other content, such as JAVA®, FLASH®, XML and so forth. The web server 240 may receive and route messages between the social networking system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as IOS®, ANDROID™, WEBOS® or BlackberryOS.

### Selecting Advertisements for Presentation Based on Types of Location Data

FIG. 3 is flow chart of one embodiment of a method for identifying advertisement content for presentation to a user based on location types of physical locations associated with the user. In other embodiments, the method includes different, additional, or fewer steps than those depicted by FIG. 3. Additionally, in some embodiments, the steps described in conjunction with FIG. 3 may be performed in different orders.

The social networking system 140 maintains 305 a user profile associated with a user of the social networking system 140 that includes characteristics or information associated with the user. For example, the user profile includes demographic information associated with a user. Additionally, the user profile includes one or more physical locations associated with the user. For example, the user profile identifies a hometown associated with the user, a current physical location associated with the user, one or more physical locations associated with locations identified to the social networking system 140 by the user, or other physical locations associated with the user.

Each physical location included in the user profile is associated with a location type describing one or more characteristics of a physical location. In one embodiment, a location type specifies a source from which a physical location was determined. A location type associated with a physical location may be selected from a set of location types. For example, a location type identifies a static physical location specified by a user (e.g., a hometown, a residence) or inferred from information associated with the user (e.g., locations to which the user checks-in, a location associated with at least a threshold amount of content associated with the user, a location associated with at least a threshold number of additional users connected to the user, etc.), another location type identifies a physical location identified in content provided to the social networking system 140 by the user (e.g., a location identified by a post to the social networking system 140 by the user, a location to which a user checks-in via a client device 110), and an additional location type identifies a physical location identified by information communicated to the social networking system by a client device 110 associated with the user (e.g., Global Positioning System coordinates communicated to the social networking system 140 by a client device 110 executing an application associated with the social networking system 140). Additionally, in some embodiments, the location type identifies a current physical location of the user. The social networking system 140 may determine if a physical location associated with the user is the user's current physical location of the user by comparing a time stamp associated with the information received from the client device 110 with a current time, as described above in conjunction with FIG. 2.

The social networking system 140 identifies 310 an opportunity to present advertisement content to the user and retrieves ad requests from the ad store 230 or from one or more third party systems 130. For example, the social networking system 140 receives a request from a client device 110 for advertisement content and retrieves ad requests in response to the received request. Characteristics associated with the user are retrieved and compared to targeting criteria included in various retrieved ad requests to determine ad requests including at least a threshold number or percentage of targeting criteria satisfied by characteristics of the user. Ad requests including at least a threshold number or percentage satisfied by characteristics of the user are identified as including advertisement content eligible for presentation to the user.

An ad request including targeting criteria specifying a physical location satisfied by a physical location included in the user profile of the user is identified 315. For example, a physical location included in the user profile satisfies targeting criteria of an ad request if the physical location included in the user profile matches a physical location identified by the targeting criteria. As another example, a physical location included in the user profile satisfies targeting criteria of an ad request if the physical location included in the user profile is within a threshold distance of a physical location specified by the targeting criteria. If the identified ad request associates minimum measures of ad quality for the user with different location types, which specifies minimum measures of user affinity for advertisement content in the identified ad request, the identified ad request is not determined to be eligible for presentation to the user without evaluating the user's affinity for advertisement content in the identified ad request in view of one or more of the minimum measures of ad quality for the user.

The social networking system 140 determines 320 a location type associated with the physical location included in the user profile satisfying the targeting criteria of the identified ad request and identifies 325 a minimum measure of ad quality for the user associated with the determined location type from the targeting criteria included in the identified ad request. For example, the social networking system 130 determines 320 a location type indicating that a physical location included in the user profile satisfying targeting criteria of the identified ad request is a physical location specified by information received by the social networking system 140 from a client device 110 and identifies 325 a minimum measure of ad quality for the user that the targeting criteria associates with a physical location specified by information received from a client device 110. The identified minimum measure of ad quality for the user represents a minimum measure of affinity for advertisement content included in the ad request for users eligible to be presented with the advertisement content or specifies a minimum likelihood of the user interacting with the advertisement content that is based on the user's affinity for the advertisement content.

Based on characteristics of the user from the user profile (as well as actions associated with the user and connections between the user and other objects maintained by the social networking system 140), characteristics of the advertisement content in the identified ad request, and targeting criteria included in the identified ad request, the social networking system 140 determines 330 a measure of ad quality of the user for advertisement content in the identified ad request based at least in part on the user's affinity for the advertisement content. In one embodiment, a model trained using characteristics of one or more additional users, characteristics of advertisement content, and targeting criteria is applied to the characteristics of the user to determine the measure of the user's affinity for advertisement content in the identified ad request, which is used to determine 330 the measure of ad quality for the user. Additionally, the social networking system 140 determines measures of affinity of other social networking system users for the advertisement content in the identified ad request. For example, the social networking system 140 determines measures of affinity (or measures of ad quality) of other social networking system users having a physical location included in their user profiles satisfying targeting criteria included in the identified ad request. In another example, the social networking system 140 determines measures of affinity for advertisement content included in the identified ad request for a global set of social networking system users or for a sampling of social networking system users.

The social networking system 140 determines 335 whether the user satisfies the targeting criteria included in the identified ad request based on the identified minimum measure of ad quality for the user and the measure of ad quality for the user. In one embodiment, the social networking system 140 ranks the measure of the ad quality for the user of the advertisement content included in the identified ad request and measures of other users' affinity for the advertisement content included in the identified ad request. Based on the ranking and the identified minimum measure of ad quality for the user, the social networking system 140 determines 335 whether the user satisfies the identified ad request's targeting criteria. For example, the social networking system 140 determines 335 that the user satisfies the identified ad request's targeting criteria if the user's measure of affinity for the advertisement content is within a range of the ranking including a percentage of users' measures of affinity for the advertisement content (e.g., if the user's measure of affinity for the advertisement content is within the top 10%, top 25%, top 30%, etc. of the users' measures of affinity for the advertisement content) specified by the identified minimum measure of ad quality for the user. As another example, the social networking system 140 determines 335 the user satisfies the identified ad request's targeting criteria if the user's measure of affinity for the advertisement content is in at least a percentile of the users' measures of affinity for the advertisement content specified by the identified minimum measure of ad quality for the user. In another example, the user is determined 335 to satisfy the targeting criteria of the identified ad request if the user's measure of affinity for the advertisement content equals or exceeds a value specified by the identified minimum measure of ad quality for the user. Hence, the user is determined 335 to satisfy the identified ad request's targeting criteria if the user is associated with a physical location satisfying a physical location specified by the ad request's targeting criteria and also has a measure of affinity for the ad request's advertisement content that satisfies a minimum measure of ad quality for the user the identified ad request's targeting criteria associates with a location type of the physical location associated with the user.

If the social networking system 140 determines 335 the user satisfies the targeting criteria of the identified ad request, the identified ad request is included in a selection process with one or more additional ad requests eligible for presentation to the user. As described above in conjunction with FIG. 2, the selection process may rank ad requests based on expected values determined for each ad request based on a bid amount of an ad request and an expected amount of user interaction with advertisement content in the ad request. In some embodiments, the bid amount of the identified ad request is based at least in part on the location type associated with the physical location in the user profile satisfying the targeting criteria of the identified ad request. For example, an advertiser associates different bid amounts with different location types, and the social networking system 140 retrieves a bid amount associated with the location type associated with the physical location included in the user profile satisfying the targeting criteria of the identified ad request.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
maintaining a user profile for a user of a social networking system including a set of physical locations associated with the user, each physical location associated with a location type;
receiving an advertisement (“ad”) request identifying an advertisement and targeting criteria, the targeting criteria identifying a physical location and identifying a minimum measure of ad quality for the user associated each of one or more location types associated with the physical location;
identifying an opportunity to present advertisement content to the user;
determining that the user profile includes a physical location matching the physical location identified by the targeting criteria;
identifying the minimum measure of advertisement quality for the user from the targeting criteria that is associated with the location type of the matching physical location from the user profile;
determining a measure of ad quality for the user based at least in part on an affinity between the user profile and the advertisement; and
determining whether to include the ad request in a selection process with one or more additional ad requests based at least in part on the determined measure of ad quality and the identified minimum measure of advertisement quality for the user.

2. The method of claim 1, wherein determining whether to include the ad request in the selection process with one or more additional advertisement requests comprises:
retrieving measures of affinity between multiple users of the social networking system and the advertisement content included in the ad request;
determining a ranking of the measure of advertisement quality for the user for the advertisement content included in the ad request relative to the retrieved measures of affinity; and
including the ad request in the selection process if the ranking of the measure of advertisement quality for the user equals or exceeds the identified minimum measure of advertisement quality for the user.

3. The method of claim 2, wherein including the ad request in the selection process if the ranking of the measure of advertisement quality for the user equals or exceeds the identified measure of advertisement quality for the user comprises:
including the ad request in the selection process if the ranking of the measure of advertisement quality for the user is within a range of the ranking specified by the identified minimum measure of advertisement quality for the user.

4. The method of claim 1, wherein a minimum measure of advertisement quality for the user associated with a location type comprises a percentile of the measure of advertisement quality for the user.

5. The method of claim 1, wherein a location type associated with physical location identifies a static location.

6. The method of claim 5, wherein the static location comprises a hometown specified by the user.

7. The method of claim 1, wherein a location type identifies a location determined from content provided by the user to the social networking system.

8. The method of claim 1, wherein a location type identifies a location specified by information received by the social networking system from a client device associated with the user.

9. A method comprising:
maintaining a user profile for a user of a social networking system including a set of physical locations associated with the user, each physical location associated with a location type;
receiving an advertisement (“ad”) request identifying an advertisement and targeting criteria, the targeting criteria identifying a physical location and, for each of one or more location types, a minimum measure of ad quality for the user;
identifying an opportunity to present advertisement content to the user;
determining whether the user satisfies a first aspect of the targeting criteria based on whether the user profile includes a physical location that matches the physical location identified by the targeting criteria;
determining whether the user satisfies a second aspect of the targeting criteria by:
determining a measure of ad quality for the user based on an affinity of the user for the advertisement,
identifying the minimum measure of ad quality that is associated in the targeting criteria with the location type of the matching physical location from the user profile, and
determining whether the user satisfies the second aspect of the targeting criteria if the determined measure of ad quality is greater than the identified minimum measure of ad quality;
determining whether the targeting criteria is satisfied based on whether both the first and second aspects of the targeting criteria are satisfied; and
providing the ad request to a selection process with one or more additional ad requests subject to the targeting criteria being satisfied.

10. The method of claim 9, wherein determining whether the user satisfies the second aspect of the targeting criteria if the determined measure of ad quality is greater than the identified minimum measure of ad quality comprises:
retrieving measures of affinity of multiple users of the social networking system for the advertisement identified by the ad request;
determining a ranking of the determined measure of ad quality relative to the retrieved measures of affinity; and
determining the user satisfies the second aspect of the targeting criteria if the ranking of the determined measure of ad quality equals or exceeds the identified minimum measure of ad quality.

11. The method of claim 10, wherein determining the user satisfies the second aspect of the targeting criteria if the ranking of the determined measure of ad quality equals or exceeds the identified minimum measure of ad quality comprises:
determining the user satisfies the second aspect of the targeting criteria if the ranking of the determined measure ad quality is within a range of the ranking specified by the identified minimum measure of ad quality.

12. The method of claim 9, wherein a minimum measure of ad quality associated with a location type comprises a percentile of the measure of ad quality of the user for the advertisement identified by the ad request.

13. The method of claim 9, wherein a location type associated with physical location identifies a static location.

14. The method of claim 13, wherein the static location comprises a hometown specified by the user.

15. The method of claim 9, wherein a location type identifies a location determined from content provided by the user to the social networking system.

16. The method of claim 9, wherein a location type identifies a location specified by information received by the social networking system from a client device associated with the user.

17. The method of claim 9, further comprising:
responsive to determining to include the ad request in the selection process with one or more additional ad requests, retrieving a bid amount from the ad request associated with the location type of the matching physical location from the user profile; and
including the ad request and the retrieved bid amount in the selection process.

18. A computer program product comprising a computer-readable storage medium having instructions encoded thereon that, when executed by a processor, cause the processor to:
maintain a user profile for a user of a social networking system including a set of physical locations associated with the user, each physical location associated with a location type;
receive an advertisement (“ad”) request identifying an advertisement and targeting criteria, the targeting criteria identifying a physical location and, for each of one or more location types, a minimum measure of ad quality for the user;
identify an opportunity to present advertisement content to the user;
determine whether the user satisfies a first aspect of the targeting criteria based on whether the user profile includes a physical location that matches the physical location identified by the targeting criteria;
determine whether the user satisfies a second aspect of the targeting criteria by:
determining a measure of ad quality for the user based on an affinity of the user for the advertisement,
identify the minimum measure of ad quality that is associated in the targeting criteria with the location type of the matching physical location from the user profile, and
determine whether the user satisfies the second aspect of the targeting criteria if the determined measure of ad quality is greater than the identified minimum measure of ad quality;
determine whether the targeting criteria is satisfied based on whether both the first and second aspects of the targeting criteria are satisfied; and
provide the ad request to a selection process with one or more additional ad requests subject to the targeting criteria being satisfied.

19. The computer program product of claim 18, wherein determine whether the user satisfies the second aspect of the targeting criteria if the determined measure of ad quality is greater than the identified minimum measure of ad quality comprises:
determine whether the user satisfies the second aspect of the targeting criteria if the determined measure of ad quality is greater than the identified minimum measure of ad quality comprises:
retrieve measures of affinity of multiple users of the social networking system for the advertisement identified by the ad request;
determine a ranking of the determined measure of ad quality relative to the retrieved measures of affinity; and
determine the user satisfies the second aspect of the targeting criteria if the ranking of the determined measure of ad quality equals or exceeds the identified minimum measure of ad quality.

20. The computer program product of claim 19, wherein determine the user satisfies the second aspect of the targeting criteria if the ranking of the determined measure of ad quality equals or exceeds the identified minimum measure of ad quality comprises:
determine the user satisfies the second aspect of the targeting criteria if the ranking of the determined measure ad quality is within a range of the ranking specified by the identified minimum measure of ad quality.
